(19) United States
(12) Patent Application Publication
(10) Pub. No.: US 2007/0275143 A1
(43) Pub. Date: Nov. 29, 2007

(54) PIE TOP FORMING APPARATUS AND METHOD

(75) Inventors: Richard I. Hoskins IV, Lake Villa, IL (US); Bernard D. Tatro, Lindenhurst, IL (US); Edwin S. Hundley, McHenry, IL (US)

Correspondence Address: BELL, BOYD & LLOYD, LLP, P.O. Box 1135, CHICAGO, IL, 60690, US

(73) Assignee: Colborne Corporation, Glenview, IL (US)

(21) Appl. No.: 11/837,897

(22) Filed: Aug. 13, 2007

Related U.S. Application Data
(63) Continuation of application No. 09/948,074, filed on Sep. 6, 2001, now abandoned.

(51) Int. Cl. A21D 6/00

(52) U.S. Cl. 426/496

(57) ABSTRACT

An apparatus and method for forming images in pie tops. The apparatus provides a frame, a cylindrical die having an image surface, a cover, a counter surface and a pie top conveyor. The die is rotatably attached to the frame and may be removed to change to other dies having different image surfaces. The counter surface provides resistance to the point of formation in the pie top. The pie top conveyor transports a continuous or non-continuous top sheet of pie dough between the die and the counter surface. The conveyor and die are made with substantially non-compressible and non-stick surfaces. After an image is formed in the top sheet of pie dough, the sheet is transported from the exit of the die to a corresponding pie bottom located on a lower conveyor and then to an oven for baking.

### PRIORITY

This application is a continuation of, claims priority to and the benefit of U.S. patent application Ser. No. 09/948,074, filed Sep. 6, 2001, the entire contents of which is incorporated herein by reference.

### BACKGROUND OF THE INVENTION

People enjoy pies throughout the world. Generally, pies are homemade or made in commercial settings and sold or served to consumers. Pies which are commercially made for resale are typically made on manufacturing lines, which are adapted to produce complete pies in an automated fashion.

Generally, pies (which includes cobblers for purpose of this application) include a tin or other container for holding the components of a pie such as the pie bottom or crust, the filling which is placed in the pie and the pie top which is placed over the filling and pie crust prior to baking, freezing or packaging. The filling for pies can include any type of filling and traditionally include fruits such as apples, cherries, blueberries and strawberries.

Generally, to make a pie in a production line, each pie tin is filled with a bottom sheet of pie dough. The pie dough bottom is molded to the shape of the pie tin and forms an interior area for receiving pie filling. The filling is added to the interior area formed in the bottom of the pie dough, and a top sheet of pie dough is then placed over the filling. The pie is then either frozen or baked in an oven. On homemade pies, it is becoming quite common to make different designs in the sheet of dough that forms the top of the pie. This is a fairly tedious and time-consuming process. Typically, such designs are not practical for commercially produced pies due to the costly and tedious hand finishing process. The types of designs currently available on commercially produced pie tops have generally been limited to simple lattice type designs. More specifically, traditional pie making devices have produced pies that look similar no matter who is selling the pies. In particular, pies sold in stores and commercial establishments generally all look the same because the pie making machines that produce the pies are limited to forming a limited number of simple pie designs.

For example, in U.S. Pat. No. 2,405,661, a pie forming apparatus is disclosed that forms perforated pie covers for covering pie bottoms. The apparatus forms a continuous lattice web of dough. The lattice pattern is made by displacing or extruding a continuous sheet of pie dough with grooves formed on the surface of a pattern roll 10. The dough is fed between a series of rollers 30, 31, 33 and 34 which transport and press the sheet of dough. The dough then feeds between the pattern roll 10 and a smooth roll 11 to form the lattice pattern in the sheet of dough. The sheet of dough having the lattice pattern is then placed on the top of a continuous line of corresponding pie bottoms. This patent also discloses lightly dusting the rolls and the pattern roll with flour throughout the operation to minimize the amount of sticking of the dough to the rolls. The apparatus however, only forms a lattice pattern in the dough, and cannot be changed to accommodate other pie top images. Furthermore, pie dough is extremely sticky and “light dusting” with flour will not enable the pie dough to effectively release from the rolls. Only very shallow lattice designs that have minimal cut out areas will be possible in this apparatus. Finally, the continuous pie dough will tend to break using such an apparatus.

Another pie forming apparatus is disclosed in U.S. Pat. No. 5,244,374. The pie forming apparatus forms a lattice pattern in pie top dough. The lattice pattern is cut into the dough by using a series of cutters to punch through the dough sheet to produce the predetermined lattice pattern on the dough. This apparatus is limited to the lattice pattern and can not be changed to form other images in the pie dough. It also leaves loose pieces of pie dough on the pie top, which adds substantial cost to the pie-making process because the loose pieces must be removed by hand.

In recent years, there has been an interest in making commercially produced pies look more interesting by increasing the variety of pie tops and also making them appear to be individually made by hand. Part of the problem in producing pies with such a homemade appearance is that currently known pie making equipment such as the machines described above tends to produce a standard, non-descript looking pie that was obviously mass produced.

Another problem with creating individualized homemade-looking pies is the nature of the pie dough itself. Pie dough is different from other types of dough, such as bread dough, in that pie dough is generally much stickier than other types of dough. Pie dough is much stickier than other types of dough because it is purposely undermixed to leave small chunks of pure shortening, or fat, exposed throughout the dough. These chunks adhere to almost every surface presently used in the pie making industry. Therefore, it is much more difficult to form three dimensional patterns in pie dough using traditional methods because the sticky pie dough tends to stick to the forming or cutting apparatus.

In light of the above described problems with commercial pie making equipment, there is a need for a pie producing apparatus that produces pies that appear to be individually made by more traditional homemade techniques. Such an apparatus must enable a pie manufacturer to quickly and easily change a production line to make pies having different types of pie tops. Further, an improved pie making apparatus must perform in a manner that prevents the pie dough from sticking to image or pattern forming components of the apparatus. An improved method is also needed for forming images and patterns in pie dough in order to produce a wider variety of pie tops that appear to be homemade or at least individually made, preferably by hand.

### SUMMARY OF THE INVENTION

The present invention provides an apparatus and method for producing pies (including cobblers), which appear to be custom made. The pie making apparatus of the present invention, which is alternatively referred to herein as the pie top forming apparatus, the pie top former or the apparatus, is adapted to form pie tops with any desired image. The images are embossed, pressed or voided in the pie top dough. Furthermore, the images may include any shapes, characters, symbols, geometric configurations, letters, openings, numbers or other designs, patterns and combinations thereof as well as any renderings.

In one embodiment of the present invention, a pie top forming apparatus includes an image die or rotating die having a raised image surface and at least one non-stick surface feature for preventing the dough from sticking to the rotating die. A counter surface, which is located adjacent to the rotating die, creates a restriction between the image surface of the rotating die and the counter surface as the raised image surface is rotated past the counter surface to form an image in a sheet of pie top dough. A pie dough conveyor feeds the pie top dough between the rotating die and the counter surface.

In one embodiment, the non-stick surface feature of the image die includes a smooth non-stick surface such as a smooth material such as a nickel based metal or TFE.

In another embodiment, the non-stick surface feature includes a heater or heating device attached to the image die to heat the surface of the die. The heat from the heater causes the fat in the pie dough to melt when the image die contacts the pie dough. The melted fat helps to reduce the stickiness of the dough so that the dough is more easily released from the die surface when the image die disengages the dough.

In one embodiment of the present invention, a pie top conveyor is provided to feed the pie top dough through the image die or rotating die. In one embodiment, the pie top conveyor includes a conveyor or conveyor belt with a non-stick surface feature. The non-stick surface feature may include a smooth non-stick surface such as a smooth material such as a nickel based metal or TFE. The smooth surface promotes the release of the pie dough from the conveyor surface.

In other embodiments, the non-stick surface feature includes directing a gas toward the contact surface of the pie dough or toward the rotating die surface to promote the release of the pie dough from the rotating die. In one embodiment, a gas such as air is forced through holes or openings forward in the rotating die surface to promote the release of the pie dough from the die surface. The rotating die includes a hollow cavity and at least one opening formed in the die surface. Air is supplied through a hollow die shaft which extends through the cavity of the die. The pressure gradient between the die cavity and die surface forces the air through the opening in the die surface and against the pie dough to cause the pie dough to release from the die surface.

In another alternative embodiment, a gas such as air is blown against the outer surface of the rotating die from a point adjacent to the die. The air is blown onto the outer surface of the die and between the outer die surface and the pie dough. The force of the air helps to separate the pie dough from the outer die surface.

In another embodiment, the non-stick surface feature includes at least one scraper positioned against the rotating die to promote the release of the pie dough from the die surface. The scraper separates the pie dough from the die surface by separating the pie dough from the die surface as the pie dough exits from between the rotating die and the counter surface.

In another embodiment, the non-stick surface feature includes a sheet of cheese cloth or other material with similar characteristics which is rotated between the rotating die surface and the sheet of pie dough. The cheese cloth sheet does not stick to the pie dough and thereby forms a non-stick barrier between the die surface and the pie dough. The cheese cloth enables the die to separate from the pie dough as an image is formed in the pie dough.

In a further embodiment, the pie top conveyor or conveyor belt is formed with a substantially non-compressible surface. The substantially non-compressible surface minimizes the downward displacement of the conveyor as the image is being formed in the sheet of pie top dough. In this manner, a clear and distinct image may be formed in the pie top dough.

Various pie dough sheets are fed into the pie forming apparatus using different feed types. In one embodiment, a non-continuous or individual sheet of pie dough is continuously fed between the rotating die and the counter surface. In another embodiment, a non-continuous sheet of pie dough is non-continuously fed between the die and the counter surface. In this embodiment, the feed delivers one sheet of pie dough to the apparatus and stops. Subsequently, the feed starts and stops after delivering each sheet of pie dough to the apparatus. In a further embodiment, a continuous sheet of pie dough is continuously fed between the die and the counter surface. In another embodiment, a continuous sheet of pie dough is non-continuously fed between the rotating die and the counter surface as described above. When individual sheets of pie dough are provided, the sheets form separate pie tops for individual pie bottoms. It should be appreciated that in the case of a continuous sheet of pie dough, the individual pie tops are subsequently separated after the image is formed.

In various embodiments, one or more rotating dies and counter surfaces are used to form an image in a sheet of pie dough. In one embodiment, the rotating die is removable from the pie forming apparatus to enable a user to change the images formed on the pie tops by using other rotating dies with different image surfaces. This enables a pie maker to quickly and easily switch the type of images of the pies produced and provides for a greater variety of pie tops. This, in turn, provides pies with a wider variety of custom appearances.

In a further alternative embodiment, two cylindrical dies are placed in series in a pie top former so that a complex image may be formed in the pie top dough in separate stages. In this embodiment, the first cylindrical die displaces a first image on the pie top dough and then the second cylindrical die displaces a second image on the pie top dough. By having multiple cylindrical dies positioned in series, a minimal amount of dough is displaced by each die, and more complex images can be formed in the dough.

In another alternative embodiment, two cylindrical dies are placed adjacent to each other in the same pie top former. Similarly, in a further alternative embodiment, two pie top forming apparatuses are placed side-by-side. These alternative embodiments enable a user to increase pie production rates. Therefore, pie manufacturers can produce increased quantities of pies having the same image or different images formed on pie tops.

In a further alternative embodiment, a non-stick surface feature of the cylindrical die includes an image surface that has at least one release edge which facilitates the release of the sticky pie dough from the cylindrical die. The release edges are formed so that the stickiness of the pie dough is minimized as the cylindrical die displaces and forms an image in the pie dough. Preferably, the release edges are angled or beveled, however, it should be appreciated that any type of edges or surfaces that promote the release of the cylindrical die from the pie dough may be used.

The present invention further provides a method of forming an image in a sheet of pie dough. The method includes the steps of feeding a sheet of pie dough on a smooth non-stick, substantially non-compressible conveyor surface between a rotating die and a counter surface. Then, a portion of the sheet of pie dough is displaced to form an image in the dough as the sheet of pie dough moves between the smooth non-stick, substantially non-compressible image forming surface of the rotating die and the counter surface.

Additional steps include adjusting the thickness of the pie dough based on the shape and thickness of the image that is being formed in the pie dough. A user may adjust the rotating die and pie top conveyor to synchronize the forming of pie tops with the movement of pie bottoms on a separate conveyor. Furthermore, the rotating die and pie top conveyor can be formed with a non-stick material such as a smooth material such as a nickel based metal or TFE to decrease the amount of pie dough that sticks to the rotating die and conveyor. Similarly, the rotating die can be formed with a heater, which heats the pie dough to promote the release of the pie dough from the die surface. Alternatively, air may also be directed through openings in the die surface to cause a pressure gradient across the die surface or air may be blown against the outer surface of the die to force the pie dough from the die surface.

It is therefore an advantage of the present invention to provide a pie top forming apparatus that is adapted to form several different images on pie tops.

It is another advantage of the present invention to provide a pie top forming apparatus that has a non-stick surface or release feature that promotes the release of the pie dough from the image surface.

It is still a further advantage of the present invention to provide a pie top forming apparatus that displaces an image in pie dough.

It is yet a further advantage of the present invention to provide a pie top forming apparatus that has removable dies having image forming surfaces where a user may form several different images in pie dough.

Additional features and advantages of the present invention are described in, and will be apparent from the following Detailed Description of the Invention and the figures.

### BRIEF DESCRIPTION OF THE FIGURES

FIG. 1 is a side perspective view of the pie top forming apparatus of one embodiment of the present invention illustrating the pie top former including the frame, an image die such as a cylindrical die, pie top conveyor and counter surface mounted below the upper dough transporting surface of the pie top conveyor and further illustrating a top dough feeder aligned with the inlet end of the pie top former, a pie bottom conveyor positioned below the frame and the feeder, and a roller drive system including gears and drive belts.

FIG. 2 is an outlet side perspective view of the pie top forming apparatus of FIG. 1 illustrating the pie top former including the frame, image die, pie top conveyor and counter surface with the cover over the die removed.

FIG. 3 is an exploded perspective view of the pie top forming apparatus of FIG. 1 illustrating the image die, cover, pie top conveyor, pie top conveyor rollers and the counter roller.

FIG. 4A is a side view of the pie forming apparatus of FIG. 1 illustrating the image die, die shaft, cover and frame.

FIG. 4B is a cross-sectional view of the pie top forming apparatus of FIG. 1 taken substantially through line 4B-4B of FIG. 4A illustrating the image die, die shaft, pie top conveyor, cover and the counter surface.

FIG. 5A is a side perspective view of the cylindrical die of FIG. 1 removed from the pie top former where the image die is forming the top portion of an apple image on a sheet of dough including arrows which show the movement of the dough as the image is being formed in the dough.

FIG. 5B is a side perspective view of the image die of FIG. 1 removed from the pie top former where the die is forming the middle portion of an apple image on a sheet of dough as the image is being formed in the dough.

FIG. 5C is a side perspective view of the image die of FIG. 1 removed from the pie top former where the die is forming the bottom portion of an apple image on a sheet of dough including arrows which show the movement of the dough as the image is being formed in the dough.

FIG. 6A is an elevation view of the pie top forming apparatus of FIG. 1 illustrating the image die and the counter surface where the die is rotating towards a sheet of dough to form an image on the sheet of dough.

FIG. 6B is an elevation view of the pie top forming apparatus of FIG. 1 illustrating the image die and the counter surface where the die is forming the front edge of an image in a sheet of dough.

FIG. 6C is an elevation view of the pie top forming apparatus of FIG. 1 illustrating the image die and the counter surface where the die is forming the middle portion of an image in a sheet of dough.

FIG. 6D is an elevation view of the pie top forming apparatus of FIG. 1 illustrating the image die and the counter surface where the die is forming the bottom edge of an image in a sheet of dough.

FIG. 6E is an elevation view of the pie top forming apparatus of FIG. 1 illustrating the image die and the counter surface where the die is rotating away from the sheet of dough.

FIG. 7A is an elevation view of the pie top forming apparatus of FIG. 1 illustrating the image die and the counter surface where the die is displacing an entire section of dough as it forms an image in the sheet of dough.

FIG. 7B is an elevation view of the pie top forming apparatus of FIG. 1 illustrating the image die and the counter surface where the die is displacing a partial section of dough as it forms an image in the sheet of dough.

FIG. 7C is an elevation view of the pie top forming apparatus of FIG. 1 illustrating the image die and the counter surface where the die is displacing a two separate sections of dough as it forms an image in the sheet of dough.

FIG. 8A is a side perspective view of the pie top forming apparatus of an alternative embodiment of the present invention illustrating the image die removed from the pie top former where the die is forming a star image on a sheet of dough.

FIG. 8B is a side perspective view of the pie top forming apparatus of another alternative embodiment of the present invention illustrating the image die removed from the pie top former where the die is forming a letter image on a sheet of dough.

FIG. 8C is a side perspective view of the pie top forming apparatus of an a further alternative embodiment of the present invention illustrating the image die removed from the pie top former where the die is forming a circle image on a sheet of dough.

FIG. 8D is a side perspective view of the pie top forming apparatus of an a further alternative embodiment of the present invention illustrating the image die forming a lattice image on a sheet of dough.

FIG. 9 is a side perspective view of a pie top forming apparatus of another alternative embodiment of the present invention illustrating two image dies aligned in series on the frame of the apparatus and further illustrating two counter surfaces, the pie top conveyor and the drive system connected to the image dies having drive rollers and drive belts that drive both image dies.

FIG. 10A is an elevation view of a pie top forming apparatus of FIG. 10 illustrating two image dies and counter surfaces aligned in series on the frame of the apparatus where a sheet of dough is being fed into the inlet side of the first image die and where the first image die is rotating towards the sheet of dough to form a first image in the dough.

FIG. 10B is an elevation view of a pie top forming apparatus of FIG. 10 illustrating two image dies and counter surfaces aligned in series on the frame of the apparatus where a sheet of dough is passing between the first image die and the first counter surface and where a first image is being formed on the sheet of dough.

FIG. 10C is an elevation view of a pie top forming apparatus of FIG. 10 illustrating two image dies and counter surfaces aligned in series on the frame of the apparatus where a sheet of dough is exiting the outlet of a first image die and passing between a second image die and a second counter surface and where the second counter surface is rotating towards the sheet of dough to form a second image in the sheet of dough.

FIG. 10D is an elevation view of a pie top forming apparatus of FIG. 10 illustrating two image dies and counter surfaces aligned in series on the frame of the apparatus where a sheet of dough is passing between the second image die and the second counter surface and where a second image is being formed on the sheet of dough.

FIG. 10E is an elevation view of a pie top forming apparatus of FIG. 10 illustrating two image dies and counter surfaces aligned in series on the frame of the apparatus where a sheet of dough is leaving the outlet of the second image die and where the final image is formed in the sheet of dough.

FIG. 11A is a side perspective view of a pie top forming apparatus of a further alternative embodiment of the present invention illustrating one image die having two or more image surfaces and further illustrating a pie top conveyor transporting a sheet of dough passing from the outlet of the image die where two images are formed in the surface of the dough.

FIG. 11B is a side perspective view of a pie top forming apparatus of another alternative embodiment of the present invention illustrating two image dies aligned side by side on two adjacent frames and further illustrating two pie top conveyors transporting sheets of dough passing from each outlet of the image dies where the sheets of dough each have an image formed in the surface of the dough.

FIG. 12 is an elevation view of a pie top forming apparatus of another alternative embodiment of the present invention illustrating release edges formed on the image die that promote the release of the dough from the die surface and further illustrating the image die and release edges forming an image in a sheet of dough.

FIG. 13 is a cross-sectional view of a pie top forming apparatus of a further alternative embodiment of the present invention illustrating an image die taken substantially through line 14-14 of FIG. 2 which uses a heater for heating the surface of the die to promote the release of the dough from the die surface.

FIG. 14 is a cross-sectional view of a pie top forming apparatus of still a further alternative embodiment of the present invention illustrating an image die taken substantially through line 15-15 of FIG. 2 which uses a gas supply system for blowing gas through openings in the surface of the image die to promote the release of the dough from the die surface.

FIG. 15 is a side perspective view of a pie top forming apparatus of another alternative embodiment of the present invention illustrating a sheet of dough formed in a wedge-like shape where the front edge of the sheet of dough is raised and slopes downward to the back edge of the sheet of dough.

FIG. 16A is an elevation view of a pie top forming apparatus employing the alternative embodiment of FIG. 15 illustrating the wedge-shaped sheet of dough being fed between an image die and counter surface.

FIG. 16B is an elevation view of a pie top forming apparatus employing the alternative embodiment of FIG. 15 illustrating the wedge-shaped sheet of dough being fed between an image die and counter surface where the sheet of dough is being displaced uniformly.

FIG. 16C is an elevation view of a pie top forming apparatus employing the alternative embodiment of FIG. 15 illustrating the wedge-shaped sheet exiting from the image die and counter surface where the sheet of dough has an even, uniform surface.

FIG. 17 is a side perspective view of a pie top forming apparatus of a further alternative embodiment of the present invention illustrating a sheet of cheese cloth or other flexible material rotating between the image die surface and the pie dough as an image is being formed in the pie dough to promote the release of the pie dough from the die surface.

### DETAILED DESCRIPTION OF THE INVENTION

The pie top forming apparatus of the present invention operates to enable a pie manufacturer to form one or more images in the upper crust or top of a pie. The present invention also allows pies to be mass produced having such images formed on tops of the pies. Preferably, the pie top forming apparatus of the present invention is attached to an automated pie making machine or assembly line for producing pies. Furthermore, the term pie or pies includes pies, cobblers and any other similar types of product.

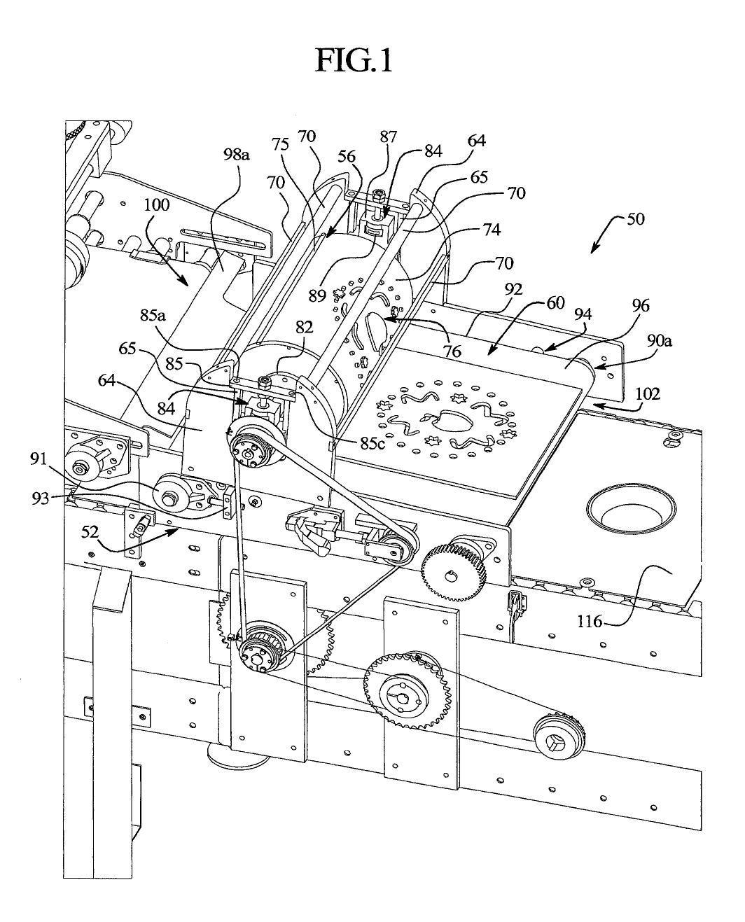

Referring now to FIGS. 1 through 4, a pie forming apparatus of one embodiment of the present invention is shown and generally designated with the numeral 50. Throughout the description, the pie top forming apparatus 50 will be alternately referred to as the pie top former or the apparatus. The apparatus 50 generally includes: a frame 52 mounted to the main frame of a pie making machine or assembly line for supporting the apparatus 50; a cover or guard 54 mounted to the frame for protecting a user from the rotating components of the apparatus; a cylindrical die 56 having an image surface 76 rotatably attached to the frame 52 for forming an image in a top sheet of pie dough; a counter surface such as counter roller 58 rotatably mounted to the frame 52 and adjacent to and slightly spaced from the die 56 for providing resistance against the image surface while forming images in a top sheet of pie dough; a pie top conveyor 60 rotatably attached to the frame 52 for transporting top sheets of pie dough between the die and counter roller to form an image in the pie top dough; and a drive system 62 for driving and rotating the rollers and the die 56 in the apparatus 50.

More specifically, the frame 52 is made out of a suitable material such as stainless steel or aluminum and provides the structural support for the pie forming apparatus 50. The frame includes two side frame panels 64, which are attached directly to the mainframe of the pie manufacturing machine using suitable attachment devices. The side frame panels 64 of the pie forming apparatus are of suitable size and thickness to support the pie forming apparatus 50. Two support bars 67 extend between the side frame panels 64 and are welded or otherwise secured to the inner surface of each side frame panel. Each panel includes an opening for mounting a die shaft tensioner 84. Ridges 65 are formed in each side frame panel to slidingly engage the tensioners 84. Furthermore, two receptacles 64a and 64b are formed in each side frame panel to enable a support bracket 85 to be mounted to each side frame panel.

The cover 54 mounts on the top of the pie forming apparatus 50 and protects a user from getting injured by the rotating components of the pie forming apparatus 50. The cover 54 is made of a suitable material such as stainless steel and is attached to the side frame panels 64. The cover 54 includes two side cover panels 66, and a plurality of support bars 70. The side cover panels 66 are attached to the side frame panels 64 by suitable fasteners. The side cover panels 66 are attached to the side frame panels 64 and cover an upper portion of the side frame panels. A plurality of support bars 70 extend horizontally between the side cover panels 66 and are attached to each side cover panel. Support bars 70 are attached to the side cover panels 66 by suitable fastening devices. The top cover panel 68 is attached to the support bars 70 and extends from the inlet side of the die 56 to the outlet side of the die. The top cover panel 68 covers almost the entire surface of the die 56 except for two rectangular openings between the bottom of the cover and the surface of the pie top conveyor 60. One opening is on the inlet side of the die 56 to enable the pie top dough to be fed between the die and the counter roller. The other opening is located on the outlet side of the die to enable a sheet of pie dough having a formed image to exit the die 56 and to be transported to a corresponding pie bottom by the pie top conveyor.

The cylindrical die 56, which is alternatively referred to as the image die, the rotating die or the die, forms an image in a top sheet of pie dough. The die 56 is rotatably attached to the side frame panels 64 and extends between the side frame panels and underneath the top cover panel 68. In the illustrated preferred embodiment the die 56 is cylindrically shaped and rotates about a horizontal axis 72. The die surface 74 is preferably smooth except for an image surface 76 which is molded, attached or otherwise formed onto or connected to the die surface 74. The image surface 76 may be any shapes, patterns, symbols, designs, openings or combinations thereof as desired by the manufacturer or user and as discussed in further detail below. The image surface 76 displaces dough in a pie top dough sheet that is fed into the pie top former to form an image in the dough that forms the top of a pie. The die surface 74 and image surface 76 may be made of any suitable material such as a polished or smooth material. The die surface 74 and image surface 76 are preferably smooth and made of a non-stick material so that the dough does not stick to either surface. Preferably, a smooth material such as a nickel based metal or TFE based surface is used to form the smooth non-stick surfaces of the die and image surface. However, it should be appreciated that any other suitable smooth non-stick surface material may be used for these surfaces. The die 56 also includes a guide 75 which extends horizontally along the surface of the die 74. The guide 75 extends vertically from the die surface 74 and enables a user to align a pie top dough sheet to be fed into apparatus 50.

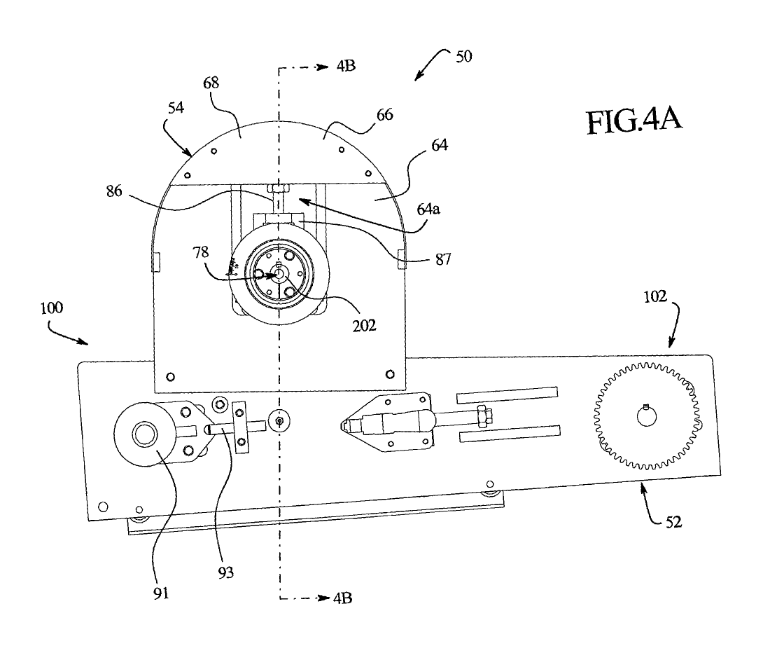

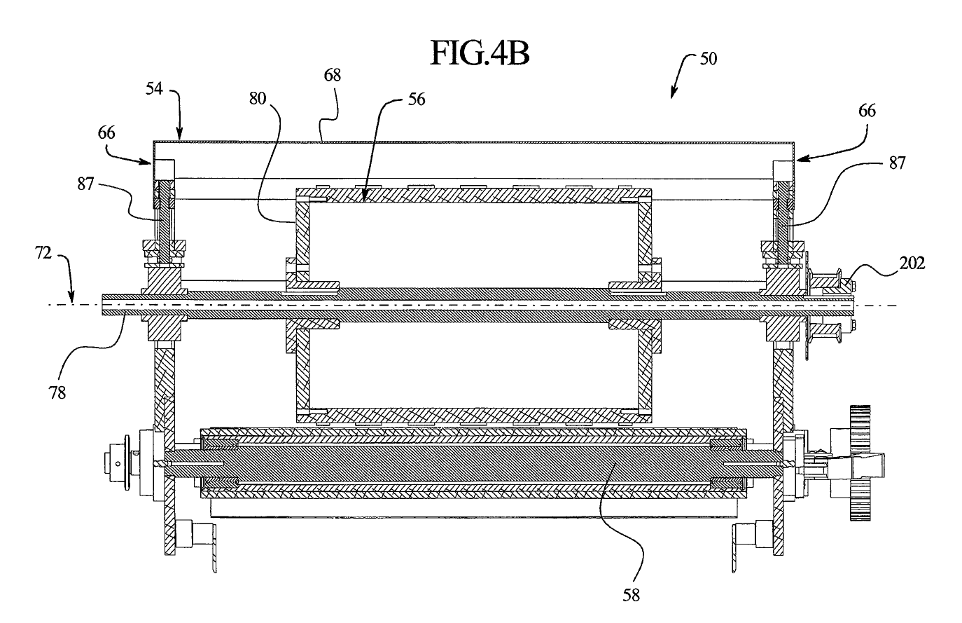

The cylindrical die 56 is substantially hollow so that die shaft 78 can be extended through the interior of the die as shown in FIG. 4B. The die shaft 78 extends through the openings in the bearing units 87. An index and control dial enable a user to adjust the synchronization of the cylindrical die 56 and the pie top conveyor 60. In this manner, a user can adjust the placement of a formed image on a top sheet of pie dough. On one end of the die shaft 78, an index 200, dial 201, fifth gear 128 and bushing cap 202 secure the shaft end in place. The index 200 and dial 201 include circular openings which enable the index and dial to be placed onto the shaft end. A user turns the dial 201 to establish a specific rotational angle for die 56, which adjusts the placement of the image surface 76. The adjustment positions the image surface to form an image at a particular position on the top sheet of pie dough. The fifth gear 128 also slides over the end of the die shaft and is secured to the shaft with bushing cap 202. The bushing cap is attached to the fifth gear 128 by suitable fasteners. As explained in further detail below, a drive belt, drive chain or independent drive turns or drives the fifth gear 128, which turns the die shaft 78.

A die shaft 78 attaches to the cylindrical die 56 and rotates the die during operation of the apparatus 50. The die shaft 78 also supports the die 56 above the pie top conveyor 60. The die shaft 78 is fixedly attached to the cylindrical die 56 so that the cylindrical die rotates as the die shaft rotates about the horizontal axis 72. Two end plates 80 are fastened to each end of the cylindrical die 56 to seal the interior of the die. The end plates 80 are fastened to each side of the die by suitable fasteners. The die shaft 78 extends through openings in each end plate 80 and to the corresponding bearing units 84. Two shaft fastening plates 82 extend over each end of the shaft through openings in the middle of each fastening plate 82. The diameter of the openings on the shaft fastening plates 82 correspond to the diameter of the die shaft 78. The shaft fastening plates 82 attach to the die shaft 78 on each side of the cylindrical die 56 and secure the die shaft to the cylindrical die by fastening to the end plates with suitable fasteners.

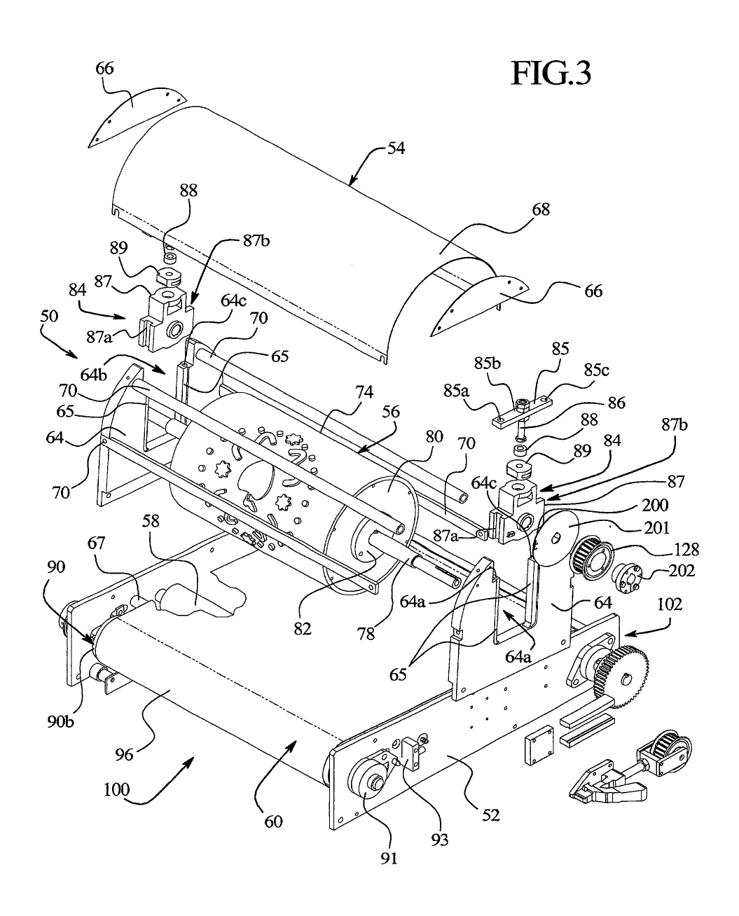

The cylindrical die 56 having image surface 76 forms an image in a pie top dough sheet by embossing, displacing, pressing or voiding the image or opening in the sheet. Different images or openings require different levels of tension between the die 56 and a sheet of dough. The die shaft tensioners 84 control the tension by raising or lowering the die 56 above the pie top conveyor 60. Two die shaft tensioners 84 are slidingly attached to the side frame panels 64 on each side of the cylindrical die 56. The shaft tensioners 84 are positioned in the openings formed in each side frame panel 64. Each tensioner 84 includes a support bracket 85 that defines circular openings 85a, 85b and 85c that extend through the support bracket. The two end openings 85a and 85c correspond to receptacles 64a and 64b on each side frame panel 64. Suitable fasteners are used to secure the support brackets 85 to the side frame panels 64. A tension rod 86 extends upward through the middle opening 85b of each support bracket 85 and through the corresponding receptacles 64a and 64b in each support bracket 85 as illustrated in FIG. 3. Each tensioner 84 includes a bushing 88 and insert 89. The insert 89 slides into an opening in bearing unit 87. The tension rod 86 extends down through a corresponding opening in bushing 88 and insert 89. A suitable fastener such as a threaded nut secures the tension rod to insert 89. The insert 89 is placed into bearing unit 87. The support bracket 85, tension rod 86 and bushing 88 attach to the bearing unit 87. Each bearing unit 87 includes a pair of channels 87a and 87b. The channels slide over the ridges 65 on side frame panels 64 to enable the tensioners 84 to move up or down within the side frame panels.

The tensioners 84 enable a user to raise or lower the die shaft 78 and cylindrical die 56 to apply the proper tension between the image surface 76 and a pie dough sheet. The tension between the image surface 76 and pie top dough determines at least, in part, the amount of displacement necessary to form a particular image in the pie dough with particular dimensions including depth or height of the image with the image surface 76 on the cylindrical die 56. The bottom of each tensioner 84 receives each end of the die shaft 78 through corresponding holes. Bearings (not shown) are placed around the ends of the die shaft 78 to enable the die shaft to rotate within each tensioner.

A pie top conveyor 60 is positioned beneath the cylindrical die 56 and between the side frame panels 64 on the frame 52. The pie top conveyor 60 transports a top sheet of pie dough between the cylindrical die 56 and the counter roller 58. Once an image is formed in the dough the pie top conveyor transports the pie dough having the formed image to be placed on a corresponding pie bottom. The belt 92 rotates about a pair of rollers 90a and 90b to transport sheets of pie dough to the cylindrical die 56. Two conveyor or plate rollers 90 are rotatably attached to the frame 52 on each side of the cylindrical die 56. The inlet roller 90a is mounted near the inlet of the cylindrical die 56. The exit roller 90b is positioned near the outlet of the cylindrical die. The rollers 90 extend between the side frame panels 64 and are rotatably attached to the panels so that the rollers can rotate in a clockwise direction with respect to the frame 52 as a person looks at the apparatus 50 from the side of the apparatus where the inlet to the die 56 is on the person's left hand side. It should be appreciated that the die rotates in a clockwise direction if a person viewed the die from the opposite side of the apparatus 50. The inlet roller 90a includes a bearing 91 and support bracket 93. The bearing 91 enables the roller to rotate inside frame panel 64. Also, bearing 91 can be adjusted to increase or decrease the tension in the pie top conveyor 60. The support bracket 93 mounts to the side frame 64 and stabilizes the bearing 91.

A conveyor belt 92 extends around each roller 90 forming a closed loop about the rollers. The conveyor belt includes an inner surface 94 and an outer surface 96 and is made of a substantially non-compressible, nonstick smooth material. The conveyor belt 92 minimizes downward displacement of the belt during the forming of an image on a pie top dough sheet. Furthermore, the smooth material used to form the belt surface helps to prevent the pie dough from sticking to the belt. It should be appreciated that any suitable substantially non-compressible, smooth non-stick material may be used to form the conveyor belt. The inner surface 94 or the conveyor belt 92 frictionally contacts the surfaces of the rollers 90 to prevent the belt from slipping off of the rollers and so the belt moves in unison with the movement of the rollers.

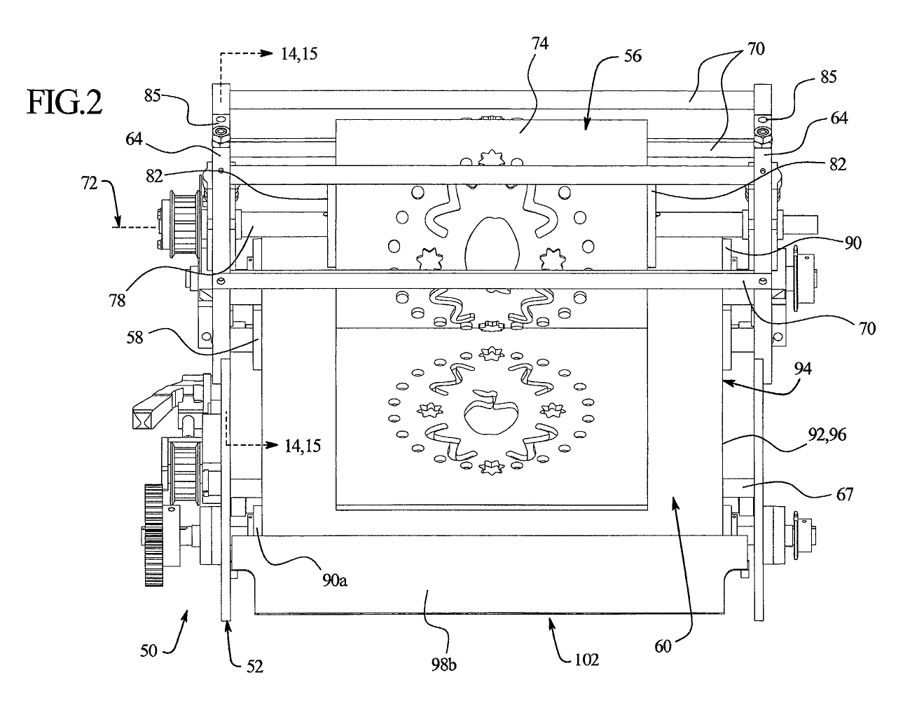

As illustrated in FIGS. 1 and 2, a slider 98a is attached at the inlet side of the pie top conveyor 60 and a slider 98b is attached to the outlet side of the conveyor for enabling the pie dough to be transferred to and from the pie top conveyor 60. The inlet side slider 98a enables the pie dough to be transferred from a feeder to the pie top conveyor 60. The outlet side slider 98b enables the pie dough having the formed image to be transported from the pie top conveyor to a corresponding pie bottom that includes the pie tin, pie crust and pie filling for the pies. Each slider surface is manufactured of a suitable material such as stainless steel, and has a smooth surface to promote the sliding of the pie dough across the panels.

The image die 56 and the conveyor 60 may be driven by any suitable drive system. For instance, as generally illustrated, the drive system may include a series of gears and belts which rotate the die 56 and the pie top conveyor 60. It should be appreciated that the drive system could alternatively include suitable chains, intermeshing gears or any other suitable interacting or independent drive mechanisms. The image die 56 and the conveyor 60 may alternatively be independently driven by suitable individual drive mechanisms or by the drive mechanism associated with main pie making machine.

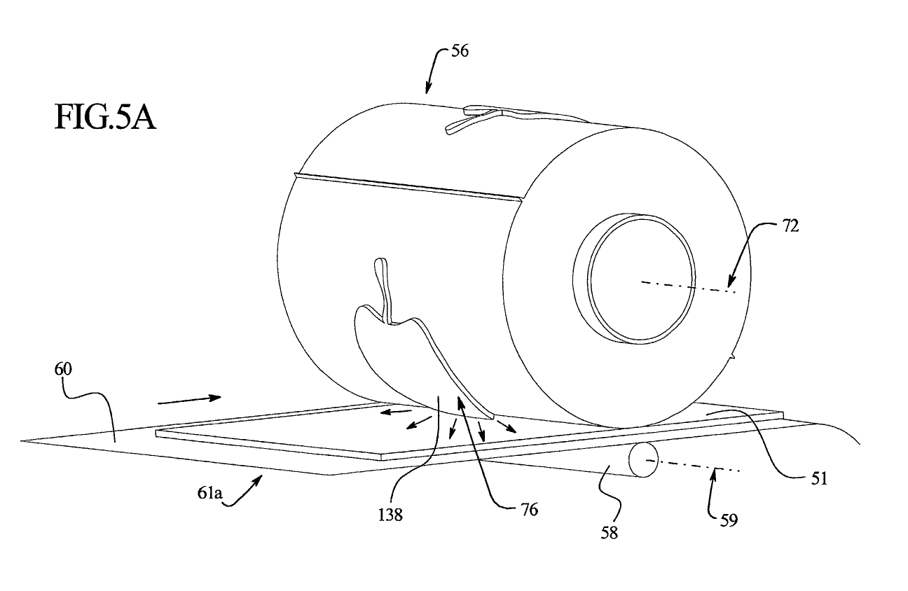

Referring now to FIGS. 5 through 7, the image cylindrical die 56 is shown in isolation along with a sheet of pie dough. The sequence of figures shows an image of an apple being formed in the sheet of pie dough. As can be seen, the raised image surface of the die forms the image of the apple that is pressed into the dough as the die is rotated past the dough. According to the present invention, the die forms the image by displacing the dough in the area of the image rather than cutting the image from the dough. The die may also emboss, press, displace or void an image or opening in a sheet of pie dough.

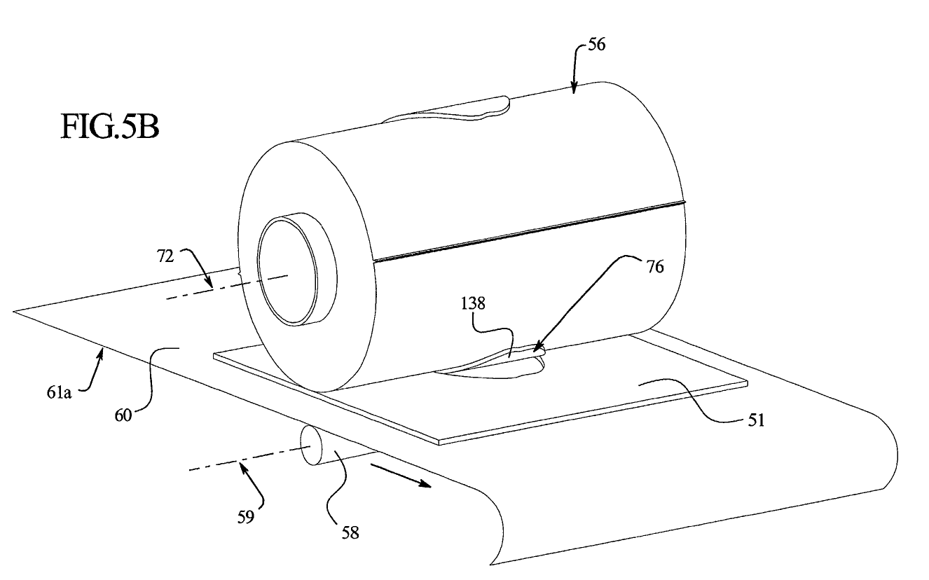

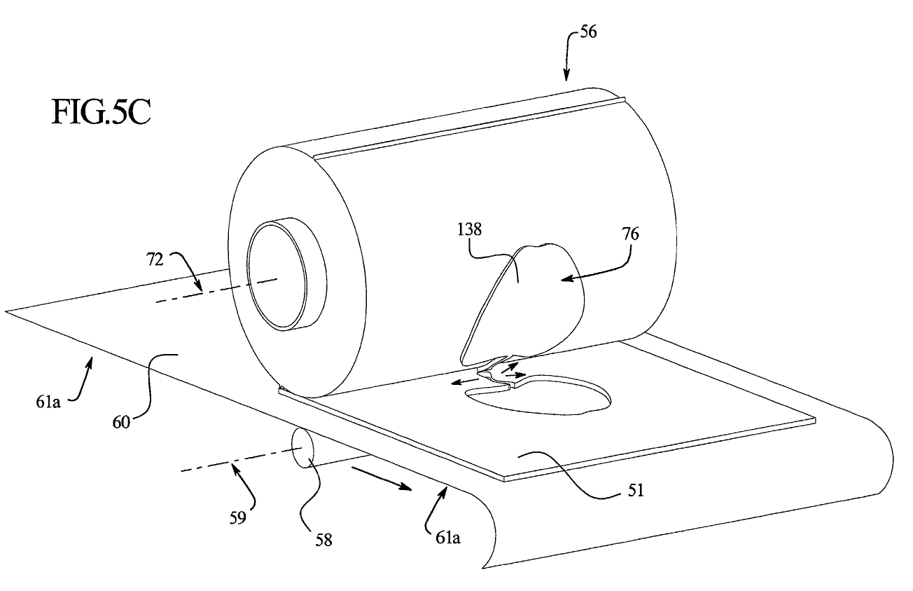

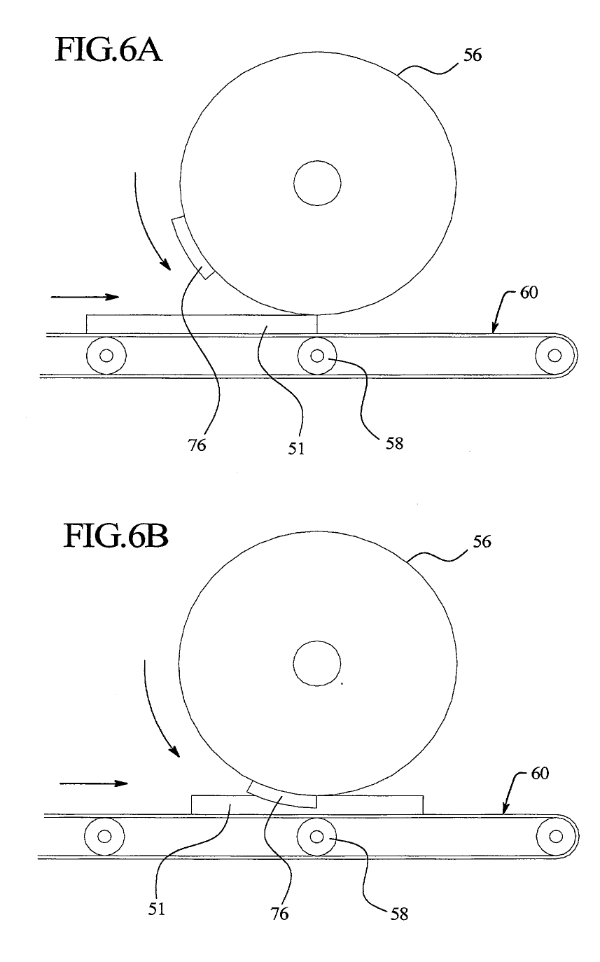

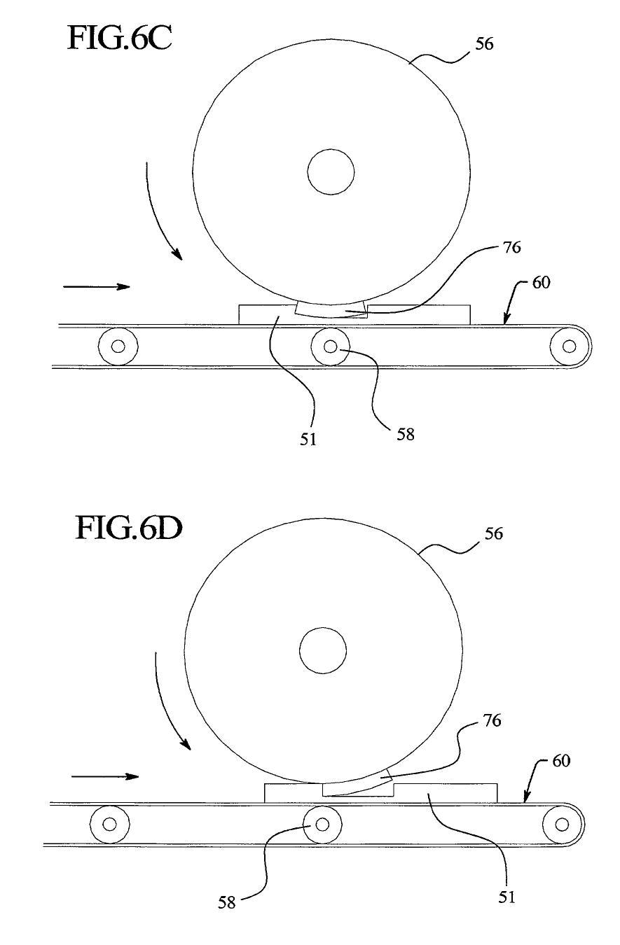

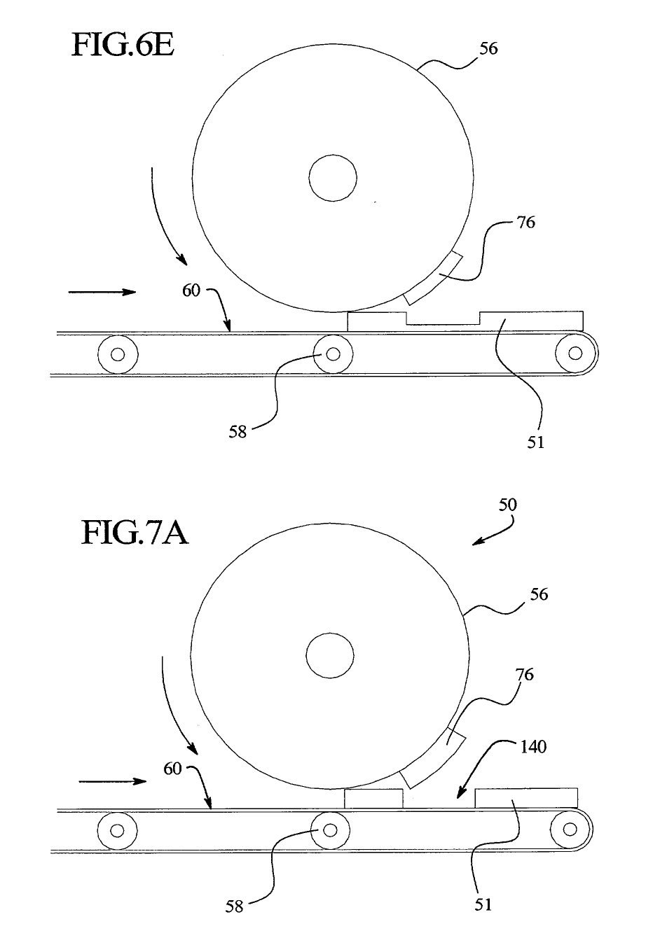

Referring to FIGS. 5A and 6A, in the embodiment, the die 56 rotates in a counterclockwise direction to rotate the apple image 138 towards the pie dough 51 to form the image in the sheet of dough. The sheet of dough 51 is fed into the inlet side of the die 56 and moves between the die 56 and the pie top conveyor 60. Directly beneath the central axis 72 of the die 56 is a counter support or surface such as the counter roller 58 which is rotatably mounted beneath the pie top conveyor 60 as shown in FIG. 6A. The counter roller 58 provides a restriction or a resistance to the inner surface 61a of the pie top conveyor 60 so that the image can be formed in the sheet of dough while minimizing the downward displacement of the pie top conveyor. As the die 56 rotates in a counterclockwise direction, the image surface rotates towards the sheet of dough 51 as the sheet of dough is being fed into the inlet side of the die. The die 56 is positioned so that the horizontal axis 72 of the die is directly aligned above the horizontal axis 59 of the counter roller as illustrated in FIG. 6A.

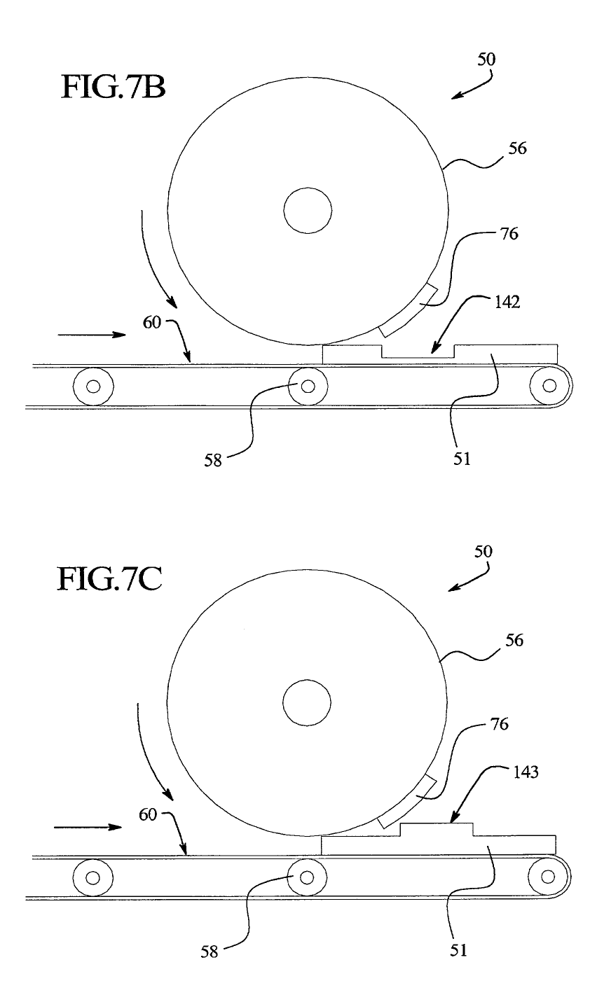

Referring to FIGS. 5B and 6B, the cylindrical die 56 rotates the image surface 76 so that the front edge of the apple image 138 contacts the sheet of dough 51 directly above the horizontal axis 59 of the counter roller 58 as illustrated in FIG. 6B. The tension of the counter roller 58 enables the apple image 138 to be firmly pressed into the pie top dough sheet 51. Because the apple image 138 is concentric with or curves about the surface of the die 56, only an edge or small cross-section of the image surface contacts the sheet of dough at any given time. The pressure of the counter roller 58 underneath the pie dough 51 and the apple image 138 on the top surface of the pie dough displaces the dough at the contact point and towards the inlet of the die 56. In this embodiment the image surface fully displaces a complete section of dough from the pie dough sheet as illustrated in FIG. 7A. The direction of the displacement of the pie dough by the image surface is shown by the arrows on the surface of the pie dough. The image surface does not cut the image from the dough, but displaces the dough uniformly within the pie dough sheet. Therefore the image is formed without wasting dough. Referring to FIG. 5C and as further illustrated in FIG. 6E, the apple image 138 has been formed and the die has rotated clear of the dough. The pie dough may then be transported from the cylindrical die 56 by the pie top conveyor 60.

In one embodiment, the pie top conveyor 60 includes a conveyor belt that is smooth, non-stick and substantially non-compressible. The non-compressible characteristic of the conveyor belt decreases the downward displacement of the conveyor as an image is being formed in a top sheet of pie dough. The belt enables an image to be formed clearly and distinctly in a top sheet of pie dough and prevents the pie top dough from sticking to the conveyor. It should be appreciated that the pie dough may be transported without the conveyor belt 60. The pie dough may be extended over a plurality of rollers and fed between the die 56 and counter surface 58 or transported using any other suitable device or method.

Referring now to FIGS. 6A through 7C, a cylindrical die 56 having an image surface 76 is illustrated where the die displaces an image into a pie dough top with an image surface. The image in this embodiment is partially displaced from the dough sheet as illustrated in FIG. 7B. It should be appreciated that an image or opening may be formed in a top sheet of pie dough by embossing, pressing, displacing or voiding the image or opening in the pie dough. Referring to FIG. 6A, a non-continuous pie dough top or sheet of pie dough 51 is fed into the inlet side of the cylindrical die. The cylindrical die 56 is tensioned so that the image surface on the die contacts the pie dough at a point and level directly above the horizontal axis of counter roller 58. As the pie dough sheet 51 is fed into and between the cylindrical die 56 and counter of the roller 58, the image surface 76 on the cylindrical die rotates towards the pie dough sheet. The pie top conveyor 60 moves the pie dough towards the cylindrical die and counter roller, as shown by the arrows on the pie dough. The pie top conveyor 60 and more specifically the counter roller 58 adds resistance to the lower surface of the pie top conveyor to minimize the downward movement of the conveyor as an image is being formed in the surface of the pie dough.

The cylindrical die 56 having image surface 76 contacts the pie dough top at a first edge or portion between the cylindrical die and the pie top conveyor 60 as illustrated in FIG. 6B. The cylindrical die 56 rotates at a speed that enables the image surface 76 to contact the pie top dough at the proper location on the pie top dough to form the corresponding image on the surface of the pie dough. The pie dough top continues to move towards the outlet of the cylindrical die 56 as the image is being formed.

Referring to FIG. 6C, a middle portion of the image is formed in the pie top dough. This portion is formed against the surface of the conveyor belt. It should be noted that only a small area of the image surface contacts the pie dough at a given time. The small point of contact enables the counter roller 58 to precisely apply pressure to the pie top conveyor 60 at the exact point of contact by the image surface. The pie dough top continues to move on the pie top conveyor 60 towards the outlet of the cylindrical die.

Referring now to FIG. 6D, the bottom portion of the image is formed or displaced in the pie dough top. The cylindrical die 56 continues to rotate in a counterclockwise direction and releases or moves the image surface away from the pie dough after the image is formed. It should be appreciated that any type of image may be formed in the pie dough top such as shapes, characters, symbols, geometric configurations, letters, openings, numbers or other designs, patterns and combinations thereof as well as any renderings.

Referring to FIG. 6E, the image is completely formed or displaced in the pie top dough top and the pie top dough moves or exits the outlet of the cylindrical die 56. The image is now formed on the pie dough top and the pie dough top can be placed onto a corresponding pie bottom to form a complete pie. It should be appreciated that the pie bottom includes any components of the bottom portion of a pie including but not limited to the pie tin, pie crust and pie filling. Preferably, the counter roller 58 and the pie top conveyor both form a restriction against the image surface 76 in an apparatus 50.

Once an image is formed, the image surface 76 on the cylindrical die 56 continues to rotate in a counterclockwise direction to engage another pie top dough sheet that will be fed into the inlet of the cylindrical die 56 between the cylindrical die and the counter roller. Preferably, the pie top dough sheets are continuously fed so that multiple pies may be made using the pie forming apparatus 50. It should be appreciated, however, that any reasonable number of images may be formed in a sheet of pie dough or that any number of pie tops may be manufactured with the pie forming apparatus of the present invention, whether it be continuous motion of individual sheets of pie dough, continuous motion of continuous sheets of pie dough, start and stop motion of individual sheets of pie dough or start and stop motion of continuous sheets of pie dough.

The images may be formed in a top sheet of pie dough by displacing an entire thickness of pie dough, a partial thickness or amount of pie dough, or multiple displacements of pie dough. Referring now to FIGS. 7A, 7B and 7C, various embodiments of the present invention are illustrated where different amounts of dough are displaced from a top sheet of pie dough. In FIG. 7A, the complete section or the entire thickness of pie dough is displaced by the image that is formed in the top sheet of pie dough. In FIG. 7B, a partial amount of pie dough is displaced from the top sheet of pie dough. In FIG. 7C, multiple sections or portions of the pie top sheet of pie dough are displaced by multiple image surfaces on the cylindrical die 56. It should be appreciated that any suitable number of pie dough sections may be displaced using one or more image surfaces on a cylindrical die 56. For example, in FIG. 7C the pie dough sheet is displaced in two different sections on the dough. The image surface 76 rotates and contact the pie dough sheet in two different locations on the sheet. The resulted pie dough sheet is formed having a raised surface portion on the pie dough sheet.

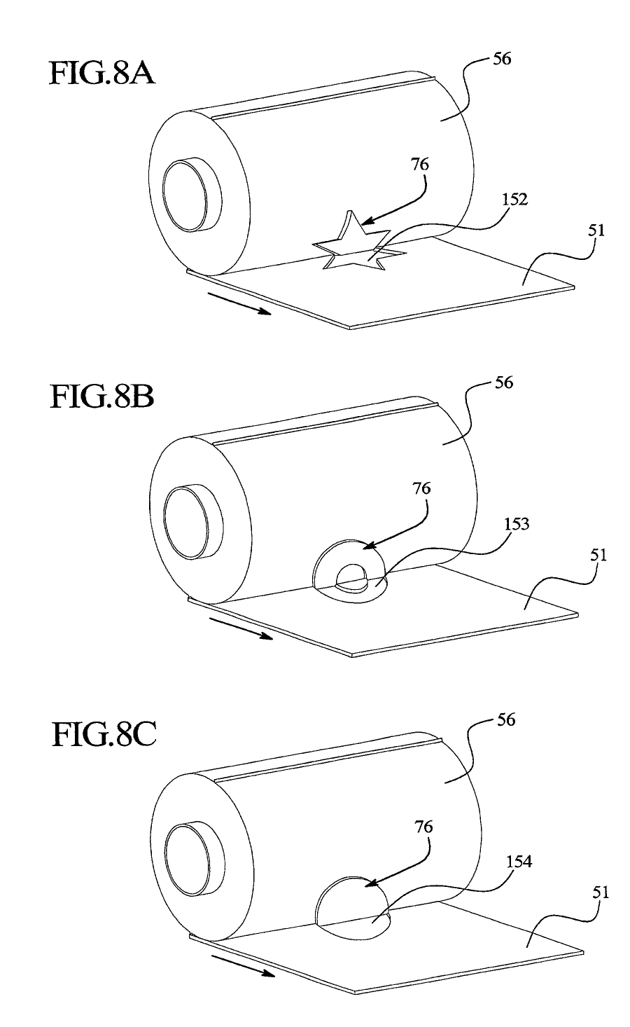

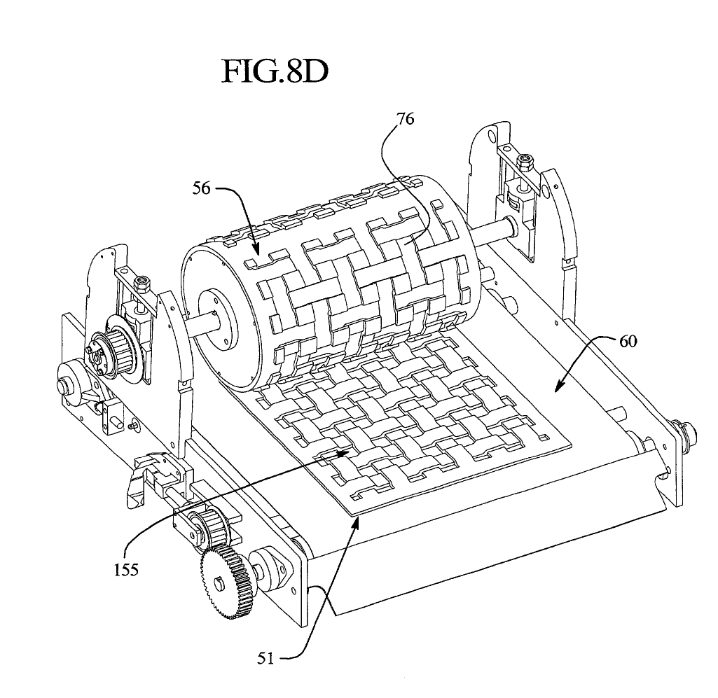

Different images may be formed in the pie top dough sheet by inserting dies having different image surfaces. A user therefore, can create pie tops having a custom image. Referring to FIGS. 8A through 8D, alternative embodiments of the pie forming apparatus 50 of the present invention are illustrated where different images are formed in the pie top dough. In FIG. 8A, a star image 152 is formed in a pie dough top. The star image is formed in the same manner as described above as the cylindrical die 56 having the star-shaped image surface is placed into the pie forming apparatus 50 to form the star image 152 on the sheet of pie dough 51. Once the star image 150 is formed in the pie top, the pie top proceeds to be placed onto a corresponding pie bottom 148 to form a complete pie. In FIG. 8B, a letter image 153, the letter “O,” is formed on the pie top. Similarly, in FIG. 8C, a circle image 154 is formed on the pie dough top 51. In FIG. 8D, a lattice pattern is embossed and voided from the pie top dough. It should be appreciated that any images such as shapes, characters, letters, numbers, symbols, geometric configurations, designs, patterns or combinations thereof may be formed on a pie top using the pie forming apparatus 50 of the present invention. The cylindrical die 56 is removably attached to the pie forming apparatus frame so that different image surfaces 76 on different cylindrical dies 56 may be interchanged into a pie former 50 to form different images on pies as desired by a user. The user of the present invention can quickly and easily change image dies or rollers to change the images on the pies.

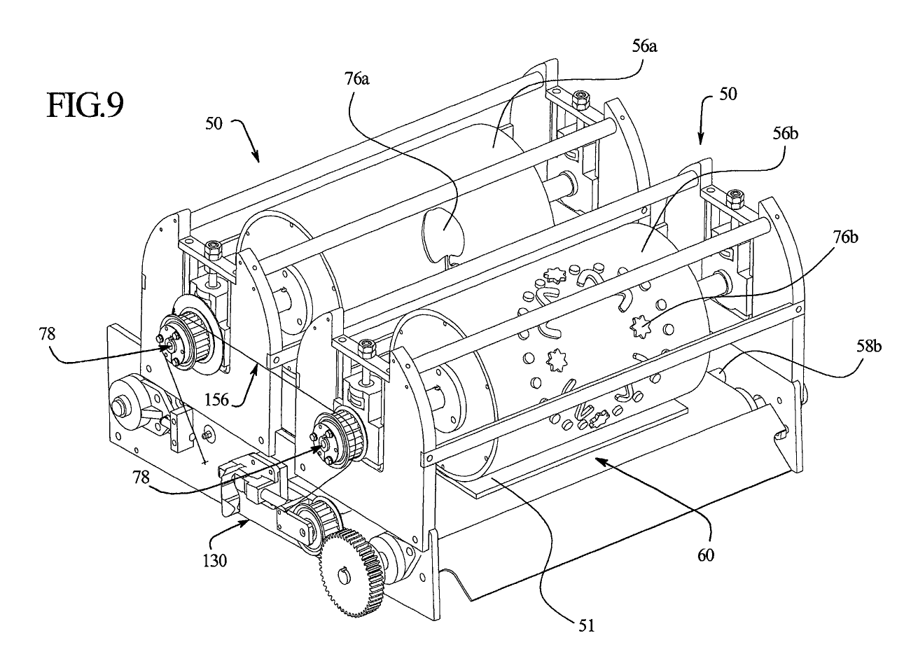

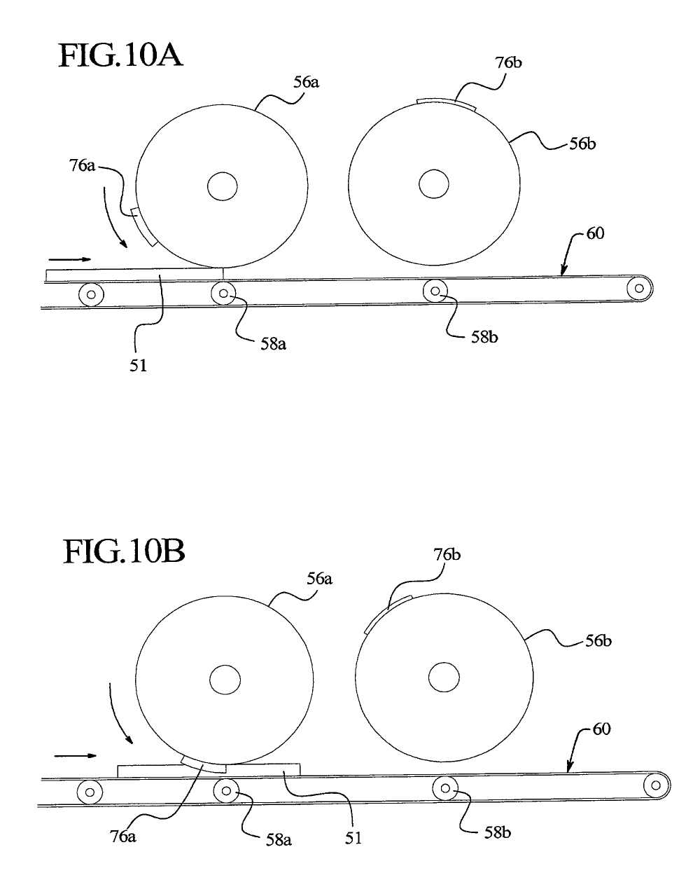

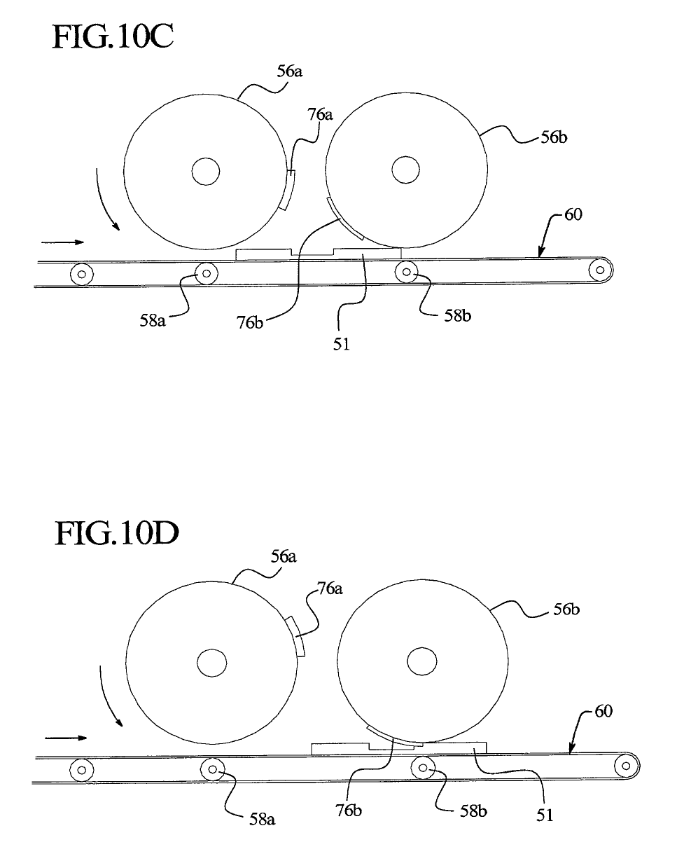

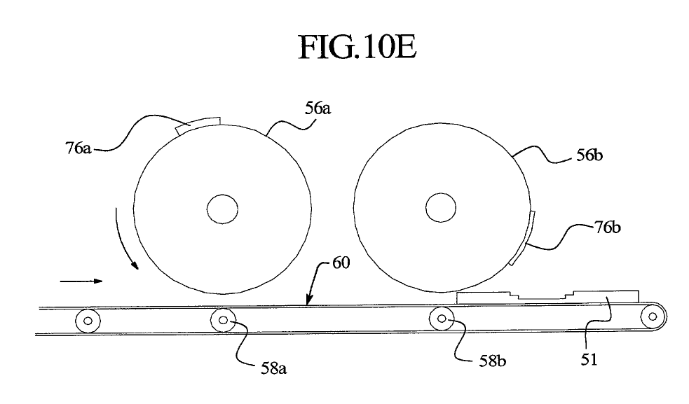

Some pie top images which are complex will require multiple levels to be formed in the pie top dough sheet. Therefore, in another embodiments two pie top forming apparatuses 50 are aligned in series for displacing different components of a complex image or for displacing different levels of a multiple level image. Referring now to FIG. 9, a further embodiment of the present invention is illustrated where two identical pie formers 50 are attached in series to a frame. In this embodiment, each pie forming apparatus 50 displaces a portion of an image on pie dough 51. By displacing a smaller portion of an image using two cylindrical dies 56, a complex or distinct image may be formed in the pie dough top 51. The cylindrical dies 56 (not shown) are attached to the frame so that each die is positioned over a single pie top conveyor 60. The drive system (not shown) for the dual cylindrical die system changes slightly so that one belt 156 drives both cylindrical die units. By having a single drive belt, both die shafts 78 of the cylindrical dies in FIG. 10 rotate at the same speed to enable an image to be properly formed in a sheet of pie dough top 51.

In this embodiment, a pie dough sheet 51 is fed into the inlet of the first cylindrical die 56a and the pie dough sheet 51 moves between the first cylindrical die 56a and the first counter roller 58a as the first portion of an image is formed on the pie dough top sheet 51. As the pie dough top sheet 51 with the first portion of the image formed on its surface exits the first cylindrical die 56a, the sheet then enters the second cylindrical 56b die at its inlet. The sheet then passes between the second cylindrical die 56b and the second counter roller 58b as a second portion of an image is formed on the surface of the pie dough sheet 51. Once the second image is formed on the pie dough sheet surface, the completed image is formed on the pie dough and the pie dough sheet 51 exits the second cylindrical die 56. This embodiment illustrates a continuous motion or feed system where a non-continuous sheet of pie dough is fed into the apparatus 50. It should be appreciated that a continuous or individual sheet of pie dough may be used and a continuous or non-continuous motion or feed system may be used in the apparatus 50.

The pie dough sheet 51 is then transported by the pie dough top conveyor 60 until it is positioned onto a corresponding pie bottom on a lower conveyor (not shown). It should then be appreciated that having the two or more pie formers in series enables complex images to be formed in the surface of a pie dough top and multiple images to be formed on a pie top. One example is if two separate circle images are to be placed on a pie top surface. One circle could be formed into the pie top surface by the first cylindrical die 56a and then the second circle may be placed in the pie top surface by the second cylindrical die 56b a small distance from the first circle image. Each cylindrical die, 56a and 56b, and corresponding image surfaces, 76a and 76b can be manufactured with a smooth, non-stick material so that the pie dough does not stick to either image surface, 76a and 76b, during formation of the image in the pie dough.

Referring now to FIGS. 10A through 10E, an example of how an image is formed by the dual cylindrical die system having separate image surfaces is shown. Each cylindrical die, 56a and 56b, is positioned over a corresponding counter roller, 58a and 58b, so that the horizontal axis of each cylindrical die is positioned directly above the horizontal axis of each counter roller. This enables each image surface, 76a and 76b, to contact the pie dough top at a point directly above the point of resistance by the counter rollers.

Referring specifically to FIG. 10A, a pie dough sheet 51 is fed into this embodiment of the pie forming apparatus. The pie dough sheet 51 enters the inlet side of the first cylindrical die 56a and moves between the die and the counter roller 58a. As the pie dough sheet moves into the inlet side of the first cylindrical die 56a, the image surface 76a on the first cylindrical die is rotating in the counterclockwise direction toward the position on the pie dough sheet where the image is to be formed. The image surface 76b on the second cylindrical 56b die is also rotating in a counterclockwise direction and is positioned so that the second image surface 76b will contact the pie dough top sheet 51 at the proper position on the pie top surface. It should be appreciated that the cylindrical dies may be adjusted so that image surfaces may contact the pie dough top surface at any position on the pie top surface as desired.

Referring to FIG. 10B, the first image surface 76a on the first cylindrical die 56a contacts the pie dough top sheet 51 at a point directly above the central horizontal axis of the first counter roller 58a. This minimizes the downward displacement of the pie dough top conveyor so that a more distinct and exact image may be formed in the pie dough top surface. The pie dough top sheet 51 moves towards the inlet of the second cylindrical die 56b as the first cylindrical die 56a begins to form the image in the pie top surface.

Referring to FIG. 10C, the pie top, having the first formed image in its surface, exits the first cylindrical die 56a and begins to enter the inlet side of the second cylindrical die 56b. The second image surface 76b on the second cylindrical die is rotating in a counterclockwise direction to position the second image surface 76b at the proper or desired location on the pie dough top sheet.

Referring to FIG. 10D, the second image surface 76b contacts the pie dough top sheet surface at a point directly above the horizontal axis of the second counter roller. Similar to the first counter roller, the second counter roller applies resistance to the pie top conveyor 60 so that the downward displacement of the conveyor is minimal, and thereby enables the image surface to form a distinct image in the pie top surface. As shown in FIG. 10D, the second image being formed in the pie top surface is overlapping the first image that was formed by the first cylindrical die and image surface. It should be appreciated that any type of one or more images may be formed or displaced in a pie top by the dual cylindrical die system.

Referring to FIG. 10E, the sheet of pie dough 51 having the formed image exits the second cylindrical die 56b. The second image surface 76b rotates away from the sheet of pie dough and rotates to meet a second or subsequent sheet of pie dough that is fed into the pie forming apparatus. Once the image is formed in the sheet of pie dough, the pie dough will be transported by the pie top conveyor 60 until it is placed on a corresponding pie bottom located on a lower conveyor.

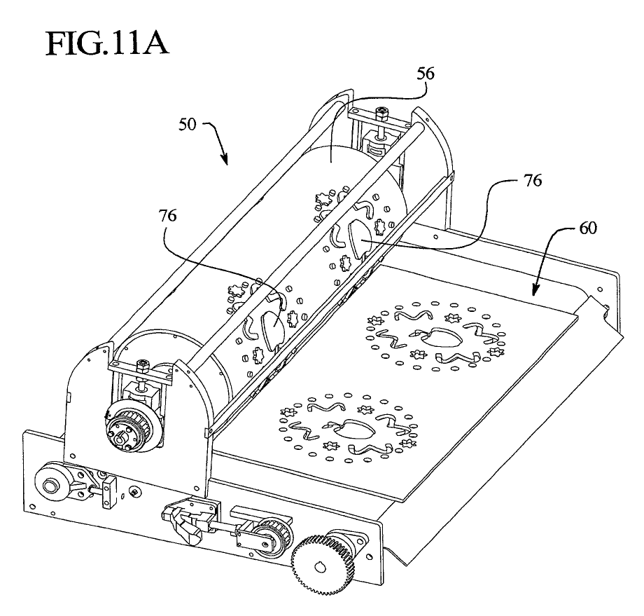

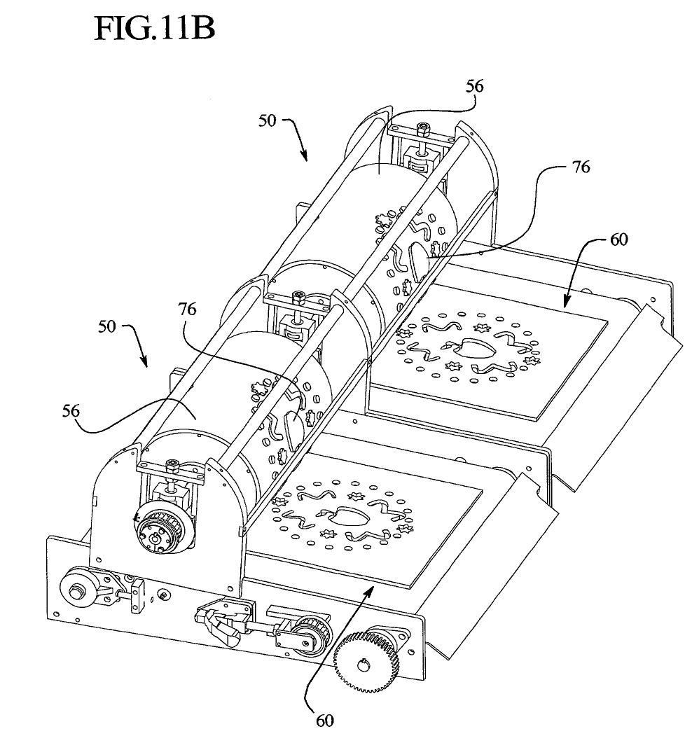

In an embodiment of the pie forming apparatus of the present invention, two or more image surfaces are placed onto one die 56. Referring to FIG. 11A, two image surfaces 76 form corresponding images in the pie top dough 51 on conveyor 60. The dual image apparatus produces twice the amount of pie tops that the single image surface apparatus can produce. Furthermore, different image surfaces may be placed on the die 56 so that two different pie tops having different images may be formed simultaneously. Therefore, the pie top forming apparatus 50 can be used to mass produce several pies having custom-looking pie tops.

Referring now to FIG. 11B, a further alternative embodiment of the pie top forming apparatus of the present invention is illustrated where two pie formers 50 are placed side by side. This embodiment illustrates how one or more pie top formers can be placed in a pie manufacturing assembly line so that several more pie tops may be manufactured by a user. Each pie forming apparatus operates as described above and forms pie tops having the same or different images. It should be appreciated that the same or different images may be formed by each pie forming apparatus as desired by user.

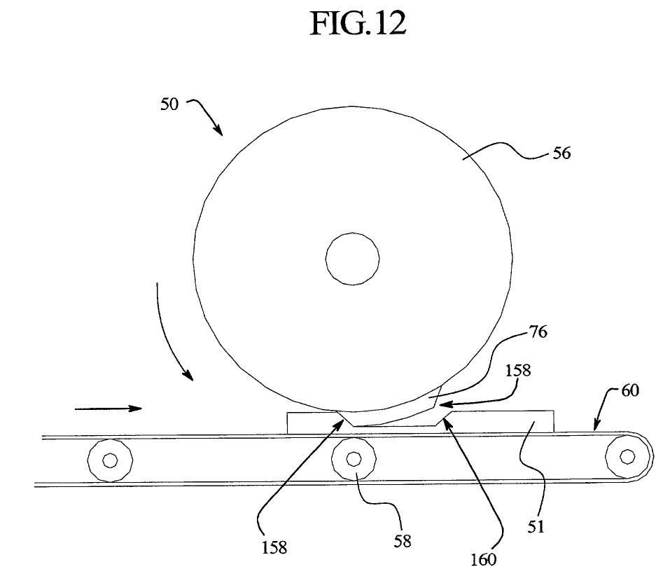

Referring now to FIG. 12, a further alternative embodiment of the pie forming apparatus of the present invention is illustrated where the image surface 76 has release edges or surfaces 158 that enable the image surface to better release from the sticky pie dough. Furthermore the release edges 158 cause more consistent displacement of the pie dough because the dough is less likely to stick to the die surface and create imperfections in the pie dough. The release edges 158 are formed at an angle or are beveled so that there is a smooth and gradual surface that contacts the pie dough top during formation at any given time. The gradual or angled surface eliminates sharp points or edges which are more likely to stick to the pie dough. The release edges 158 also enable the image surface 76 to pull away from the pie dough top surface after formation. Preferably, the release edges 158 are combined with the smooth or non-stick surface of the image surface so that sticking is minimized. As shown, the release edges 158 form a corresponding surface 160 in the pie top surface so that upon completion the image formed in the pie top will have a similar edge as shown in FIG. 12 where the edges are angled or beveled.

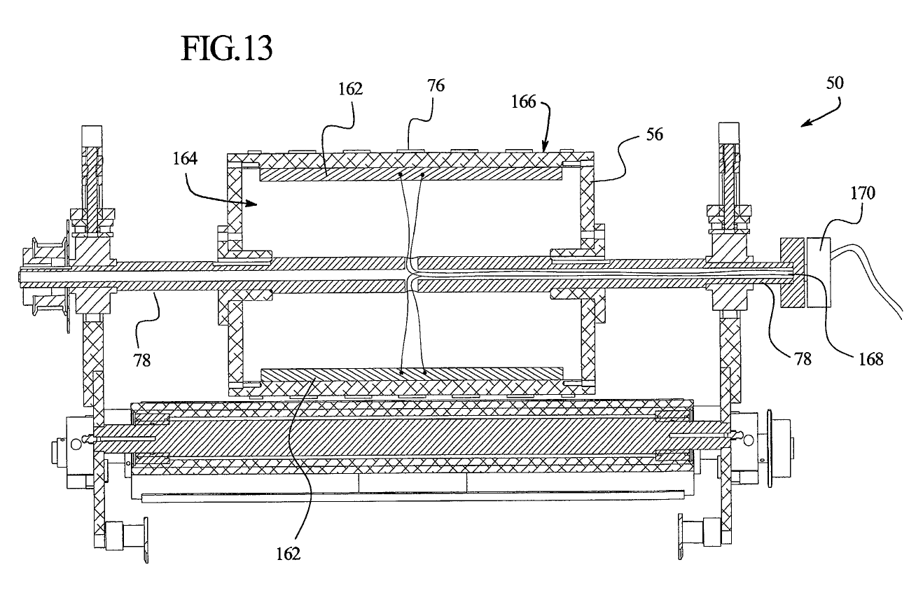

Referring now to FIG. 13, in still a further alternative embodiment of the present invention, a heater 162 is attached to the interior 164 of the cylindrical die 56. The heater heats the cylindrical die surface 166 and the image surface 76 on the cylindrical die. The heated cylindrical die surface 166 and corresponding image surface 76 heats the pie dough 51 when the surface contacts the pie dough. The heat from the surface of the cylindrical die heats the pie dough and melts the fat in the layer of the pie dough adjacent or engaging the die. The fat acts as a lubricant or film between the pie dough top and the cylindrical die surface 166 so that sticking of the pie dough to the cylindrical die surface is minimized. Electrical leads on the heater are attached to electrical wiring which connect the heater to an outside electrical source through the interior area 168 of the die shaft 78. The electrical leads and wiring are suitably manufactured so that the leads, wiring and heaters are able to rotate as the cylindrical die and corresponding shaft rotate. The electrical wiring connects to an electrical contact 170 located outside of the cylindrical die 56 and on the frame of the pie forming apparatus 50. The contact 170 attaches to the end of the die shaft 78 and provides an electrical current from a power source to the electrical wiring.

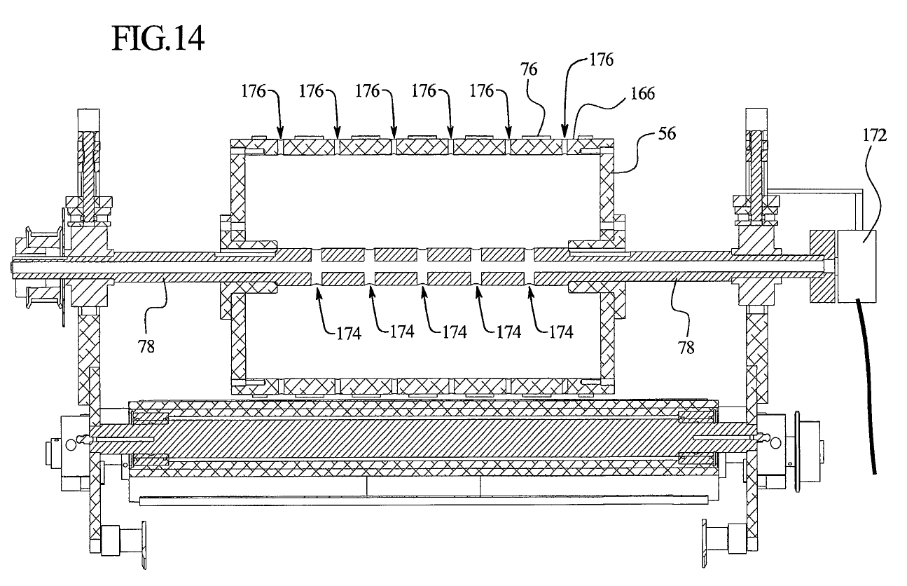

Referring now to FIG. 14, another alternative embodiment of the pie forming apparatus of the present invention is illustrated. A compressed gas such as nitrogen or air is supplied by a compressor or similar device (not shown) to die 56. The gas is transported through suitable tubing to the interior of the hollow die shaft 78 that supports the cylindrical die. The air moves through the die shaft 78 and is pressurized so that the air is forced out of openings 174 formed in the die shaft. Then, as the air passes into the interior of the cylindrical die 56, the pressure of the air causes the air to move out of openings 176 formed in the cylindrical die surface 166. As the air pushes out of the openings 176 of the cylindrical die surface, it pushes against the pie dough and enhances the release of the pie dough from the cylindrical die surface 166. In an alternative embodiment, the compressed gas is blown onto the outer surface of the die 56 from tubing or a similar device that is located adjacent to the point where the die surface contacts the pie top dough. The force of the compressed gas pushes the pie top dough from the die surface as the pie dough exits from between the die and counter surface.

It should also be appreciated that any type of gas that promotes the release of the image surface from the pie dough may be used in this embodiment. In other embodiments, the non-stick surface features of the die and pie top conveyor are combined with the release edge feature of the image surface. It should be appreciated that apparatus may include each of the non-stick features including the release edge feature independently, any combination of the non-stick surface features including the release edge feature, or all of the non-stick surface features including the release edge feature.

The thickness of the pie top dough can be adjusted to accommodate different image surfaces that form images with varying displacement depths in the pie dough. In one embodiment, the pie dough thickness is increased or decreased uniformly across the entire sheet of pie dough to accommodate a particular image surface.

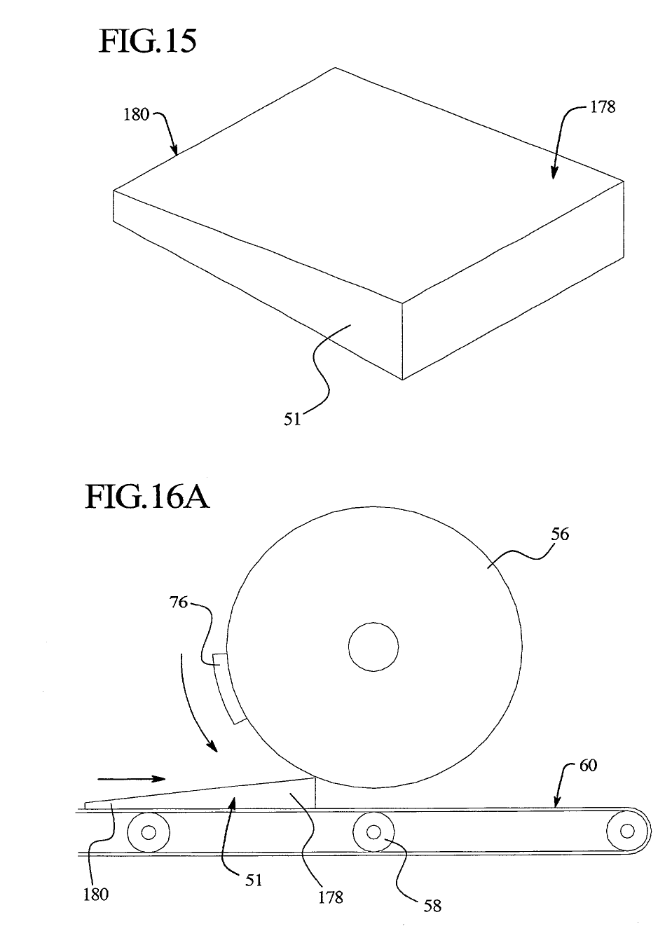

In an alternative embodiment, the thickness of the pie dough can be adjusted so that the thickness is not uniform across the sheet of pie top dough. Referring now to FIG. 15, an alternative embodiment of the present invention is illustrated where the sheet of pie dough 51 is modified so that one edge 178 of the pie dough sheet is raised or elevated and gradually slopes downward to a lower edge 180. The configuration in this embodiment of the pie dough sheet resembles a wedge-like shape and preferably, the elevated edge 178 of the pie dough sheet is fed into the inlet side of a cylindrical die first. The raised or elevated portion of the pie dough top sheet will be displaced towards the lower edge 180 of the pie dough top sheet. Therefore, the pie dough will be evenly and uniformly displaced while forming an image in the pie top. In operation, the elevated edge 178, which has a greater quantity of pie dough, is displaced towards the lower edge 180 the pie dough sheet. As the raised or elevated surface 178 of the pie dough sheet is displaced, it fills or adds to the lower area or edge 180 of the pie dough sheet and uniformly levels the pie dough sheet.

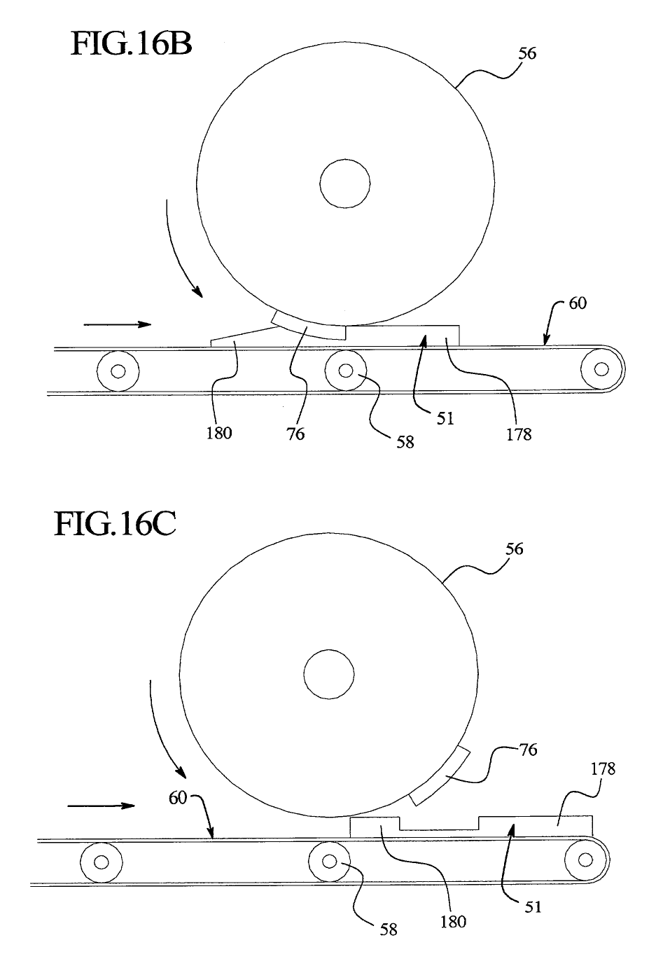

Referring now to FIG. 16A through 16C, an example of the alternative embodiment of FIG. 15 is illustrated where the wedge-shaped pie dough sheet 51 is fed into the inlet of a cylindrical die 56 in a pie forming apparatus 50 of the present invention. Referring to FIG. 16A, the cylindrical die 56 rotates in a counterclockwise direction as described above and the image surface 76 of the cylindrical die rotates towards the pie dough sheet 51 to contact the sheet at a point above the central horizontal axis of the counter roller 58.

Referring to FIG. 16B, the image surface 76 contacts the pie dough sheet 51 at the point adjacent to the counter roller 58 and displaces an image in the pie dough. The raised surface or edge 178 of the pie dough sheet 51 is displaced towards the lower surface or edge 180 of the pie dough sheet. The arrows on the pie dough sheet show the movement of the pie dough as it is being displaced by the image surface 76.

Referring to FIG. 16C, the complete image is formed in the pie dough sheet 51 as the image surface 76 rotates away from the sheet. The pie dough sheet 51 exits from the die 56 having a formed image. Furthermore, the resultant pie top has a more uniform or evenly displaced surface because the dough on the raised surface side of the pie dough sheet was displaced towards the lower surface 180 on the sheet.

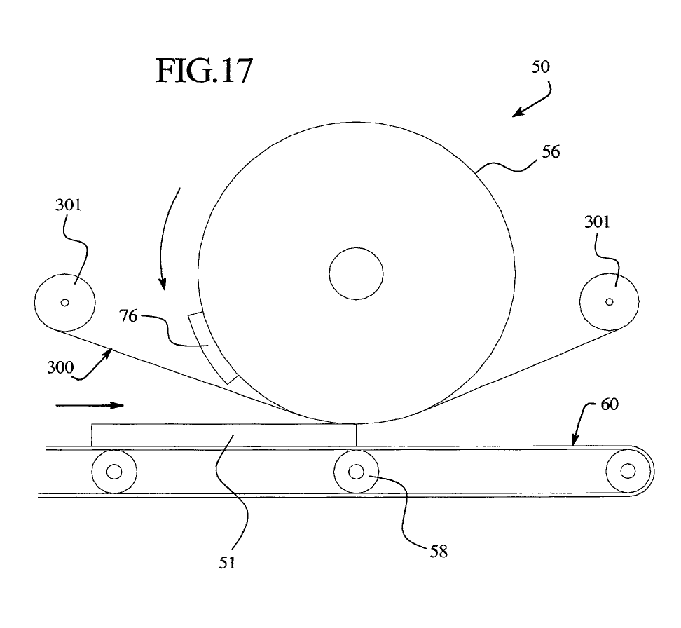

The pie dough can be released from the image die surface using a non-stick material such as cheese cloth that forms a porous barrier between the pie top dough and the image die surface. Referring now to FIG. 17, the cheese cloth or similar material 300 extends about two rollers 301. The rollers 301 rotate the non-stick cheese cloth 300 between the die 56 and the pie top dough 51. As the image surface 76 rotates and engages the pie top dough 51, the cheese cloth is pressed into the pie dough by the image surface. The cheese cloth molds to the image surface 76 so that the image formed in the pie dough 51 is not affected by the presence of the cheese cloth between the die and the pie dough. When the pie top dough 51 having the formed image exits the die 56, the cheese cloth prevents the pie dough from sticking to the die. Instead the pie dough, which is contacting the non-stick cheese cloth, releases from the cheese cloth and remains on the pie top conveyor 60.

In another alternative embodiment which is not illustrated, a scraper or similar device prevents the pie top dough from sticking to the cylindrical die. The scraper is an elongated planar device that has a top and bottom edge. The scraper is preferably mounted to the frame and adjacent to each end of the die. The scraper extends to a point near the contact area between the die and the pie dough. As the pie dough exits from between the die and counter surface, any pie dough that sticks or adheres to the die surface contacts the scraper and releases from the die surface. The scraper therefore, scrapes or removes the pie dough from the die surface during the forming of an image in the pie dough. It should be appreciated that any size and number of scrapers may be used to promote the release of the pie dough from the die surface.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

The invention is claimed as follows:

1. A method of forming a same image on each of a plurality of individual non-continuous top sheets of uncooked pie dough for a plurality of pies, said method comprising:
individually feeding each individual top sheet of uncooked pie dough on at least one conveyor toward an image die, said image die having a smooth image forming surface, said image forming surface made of a non-stick material;
individually feeding each individual top sheet of uncooked pie dough on the at least one conveyor through a space between the image die and a counter support positioned below the image die, wherein
(i) the at least one conveyor includes a substantially non-compressible conveyor belt having an inner surface and an outer surface,
(ii) each said individual top sheet of uncooked pie dough pie dough is feed on the outer surface of the conveyor belt, and
(iii) said counter support engages the inner surface of the conveyor belt; and
for each individual top sheet of uncooked pie dough feed by the at least one conveyor through the space between the image die and the counter support,
(a) causing the image forming surface to displace a portion of said individual top sheet of uncooked pie dough to form the image in the individual top sheet of uncooked pie dough, and
(b) causing the image die to cause an active release of the individual top sheet of uncooked pie dough from the image forming surface, said active release being in addition to any active release caused by the smooth non-stick material of the image forming surface.

2. The method of claim 1, wherein causing the image die to cause the active release of the individual top sheet of uncooked pie dough from the image forming surface includes causing the image die to heat the individual top sheet of uncooked pie dough.

3. The method of claim 1, wherein causing the image die to cause the active release of the individual top sheet of uncooked pie dough from the image forming surface includes causing the image die to direct a gas toward the individual top sheet of uncooked pie dough.

4. The method of claim 1, wherein the image forming surface includes at least one angled release edge, and causing the image die to cause the active release of the individual top sheet of uncooked pie dough from the image forming surface includes causing the angled release edge to release the individual top sheet of uncooked pie dough.

5. The method of claim 1, which, prior to individually feeding each individual top sheet of uncooked pie dough on the at least one conveyor through the space between the image die and the counter support, forming each individual top sheet of uncooked pie dough with a variable thickness.

6. The method of claim 1, wherein the image is continuous.

7. The method of claim 1, wherein the image is non-continuous.

8. The method of claim 1, which includes rotating the image die continuously for the plurality of individual non-continuous top sheets of uncooked pie dough.

9. The method of claim 1, which includes for each individual top sheet of uncooked pie dough, starting and stopping rotation of the image die to form the image in said individual top sheet of uncooked pie dough.
